(19) United States
(12) Patent Application Publication
(10) Pub. No.: US 2011/0075298 A1
(43) Pub. Date: Mar. 31, 2011

(54) FLUID DYNAMIC BEARING SYSTEM HAVING A LOW OVERALL HEIGHT AND A SPINDLE MOTOR HAVING THIS KIND OF BEARING SYSTEM

(76) Inventors: Andreas KULL, Donaueschingen (DE); Mathias Wildpreth, Villingen-Schwenningen (DE)

(21) Appl. No.: 12/886,683

(22) Filed: Sep. 21, 2010

(30) Foreign Application Priority Data
Sep. 30, 2009 (DE) 10 2009 043 590.5
May 12, 2010 (DE) 10 2010 020 317.3

(51) Int. Cl. G11B 5/60; F16C 32/06; H02K 7/08; B21D 53/10

(52) U.S. Cl. 360/234; 384/115; 384/112; 310/90; 29/898.02; G9B/5.229

(57) ABSTRACT

Proposed is a fluid dynamic bearing system having a bearing bush, a shaft rotatably supported in a bearing bore of the bearing bush and a hub connected to the shaft. A bearing gap filled with bearing fluid and having an axial section is defined between the shaft, the bearing bush and the hub. A first and a second fluid dynamic radial bearing are disposed along the axial section of the bearing gap, the radial bearings being marked by grooved bearing patterns on the associated bearing surfaces of the shaft and/or of the bearing bush. The two radial bearings have a mutual distance d_{L} measured from an apex line of the first radial bearing to an apex line of the second radial bearing. A separator groove is disposed in the bearing bush or in the shaft in the axial section of the bearing gap between the two radial bearings and has an axial length l_{S}. According to the invention, the ratio between the distance d_{L} and the length l_{S} is greater than 5 (five).

### BACKGROUND OF THE INVENTION

The invention relates to a fluid dynamic bearing system having a low overall height according to the characteristics outlined in the preamble to claim 1. These kinds of fluid dynamic bearings are used for the rotatable support of motors, including spindle motors that are in turn used for driving disk drives, fans and suchlike.

### PRIOR ART

Fluid dynamic bearings as used in spindle motors generally comprise at least two bearing parts that are rotatable with respect to one another and that form a bearing gap filled with a bearing fluid, such as air or bearing oil, between associated bearing surfaces. Radial bearings and axial bearings are provided that have grooved bearing patterns associated with the bearing surfaces and that act on the bearing fluid in a well-known manner. These grooved bearing patterns, taking the form of depressions or raised areas, are usually formed on one or on both the opposing bearing surfaces and have a minimal depth of only a few micrometers. The grooved bearing patterns act as bearing and/or pumping patterns that generate hydrodynamic pressure within the bearing gap when the bearing parts rotate with respect to one another. In the case of radial bearings, sinusoidal, parabolic or herringbone patterns, for example, are used that are distributed perpendicular to the rotational axis of the bearing parts over the circumference of at least one bearing part. For axial bearings, spiral-shaped grooved bearing patterns, for example, are used that are mainly disposed perpendicular about a rotational axis. The grooved bearing patterns are preferably formed on the bearing surfaces using an electrochemical machining process (ECM).

In a fluid dynamic bearing of a spindle motor for driving hard disk drives according to a well-known design, a shaft is rotatably supported in a bearing bore of a bearing bush. The diameter of the bore is slightly larger than the diameter of the shaft, so that a bearing gap filled with bearing fluid and having a width of only a few micrometers remains between the surfaces of the bearing bush and of the shaft. The surfaces facing one another of the shaft and/or of the bearing bush have pressure-generating grooved bearing patterns forming a part of at least one fluid dynamic radial bearing. A free end of the shaft is connected to a hub that has a lower, flat surface which, together with an end face of the bearing bush, forms a fluid dynamic axial bearing. For this purpose, one of the surfaces facing each other of the hub or of the bearing bush is provided with pressure-generating grooved bearing patterns.

Spindle motors of a conventional design used for driving 2.5 inch hard disk drives have an overall height of some 9.5 millimeters. Of this, about 4 to 5 millimeters is accounted for by the fluid dynamic bearing system, i.e. alongside the shaft/hub assembly, this represents the entire axial length of the bearing. It is preferable if two fluid dynamic radial bearings are provided that are spaced apart from one another and separated from each other by a separator groove. Here, each of the two radial bearings has an axial length, for example, of 1.5 millimeters and the separator groove of approx. 1 millimeter, thus producing an overall bearing length of 4 millimeters.

It is known to use electrochemical machining (ECM) to work the grooved bearing patterns of the radial bearings and those of the axial bearings into the bearing surfaces. Here the grooved bearing patterns, measured from the surface of the bearing surfaces, are cut to a depth of up to 1.5 to 15 micrometers. The separator groove is comparably much deeper, for example, 20 to 100 micrometers, and is formed in the bearing surface of the bearing bush or of the shaft using a conventional machining technique, such as turning or milling. The separator groove has such a depth because in this way friction between the surfaces of the bearing parts can be reduced and consequently the spindle motor that is rotatably supported by this bearing requires less input power.

Compact fluid dynamic bearing systems that have a low overall height are in particular demand for use in drive systems for hard disk drives, particularly for mobile applications. For example, a reduction in the overall height of the bearing of 2.5 millimeters necessitates a considerable reduction in the axial length of the radial bearings. For this purpose, the axial length of the separator groove has to be greatly reduced so that the radial bearings can still be made sufficiently large. Due to the relatively short axial length of the radial bearings, it is difficult on the one hand to manufacture the bore of the bearing bush so that the bearing gap has a predetermined width and on the other hand to manufacture the separator groove using suitable turning or milling methods without impairing the bearing surfaces. Moreover, unavoidable manufacturing tolerances have a stronger effect when the overall length is only 2-3 mm than in fluid dynamic bearings that have conventional dimensions.

What is more, a reduction in the overall height of the bearing of 2.5 millimeters necessitates a considerable reduction in the axial length of the two radial bearings. However, the short axial length of the radial bearings and the minimal bearing spacing go to significantly decrease bearing stiffness. The bearing stiffness of a fluid dynamic bearing depends particularly on the rotational speed, the viscosity of the bearing fluid as well as the diameter (surface) of the radial bearing surfaces. The greater the chosen parameters, the greater is the bearing stiffness. At the same time, however, bearing friction is also increased, so that an increase in these parameters may not be an appropriate method of improving bearing stiffness. A decrease in the width of the bearing gap also goes to increase bearing stiffness. At the same time, however, this would also increase bearing friction and considering current bearing gap widths of only a few micrometers is hardly technically viable.

### SUMMARY OF THE INVENTION

It is the object of the invention to provide a fluid dynamic bearing system having a low overall height that has comparable bearing stiffness to known bearing systems.

A further object of the invention is to provide a fluid dynamic bearing system that, compared to known bearing systems having an upper axial bearing, may be manufactured with improved precision, more simply and at lower cost.

This object has been achieved according to the invention by a bearing system according to the characteristics outlined in patent claim 1.

Preferred embodiments and further advantageous characteristics of the invention are cited in the subordinate claims.

Proposed is a fluid dynamic bearing system having a bearing bush, a shaft rotatably supported in a bearing bore of the bearing bush and a hub connected to the shaft. A bearing gap filled with bearing fluid and having an axial and a radial section is defined between the shaft, the bearing bush and the hub. A first and a second fluid dynamic radial bearing are disposed along the axial section of the bearing gap, the radial bearings being marked by grooved bearing patterns on the associated bearing surfaces of the shaft and/or of the bearing bush. The two radial bearings have a mutual distance d_{L}, measured from an apex line of the first radial bearing to an apex line of the second radial bearing. At least one fluid dynamic axial bearing is disposed along the radial section of the bearing gap, the fluid dynamic axial bearing being defined by grooved bearing patterns provided on associated bearing surfaces of the bearing bush and of the hub. A separator groove is disposed in the bearing bush or in the shaft in the axial section of the bearing gap between the two radial bearings and has an axial length l_{S}.

According to the invention, the ratio between the distance d_{L} between the two radial bearings and the length l_{S} of the separator groove is greater than 5 (five), preferably greater than 8 (eight).

The axial length of the separator groove is reduced here to a minimum, so that the radial bearing can be made as large as possible in an axial direction. The relatively large ratio between the bearing distance and the axial length of the separator groove of greater than 5 (five), preferably however greater than 8 (eight), provides the greatest possible bearing stiffness for this type of bearing construction.

In the bearing system according to the invention, the length of the joint between the shaft and the hub remains substantially unchanged with respect to previous bearing systems. This generally takes the form of an interference fit, a welded joint and/or a bonded joint. Thus the reduction in the overall height of the bearing system is borne by the bearing length, i.e. both the axial length of the radial bearings as well as their mutual distance apart, which is determined by the preferably very narrow separator groove, are reduced.

Since the axial length of the separator groove is now greatly reduced, it is possible to produce this groove using electrochemical machining (ECM). Compared to the bearings in the prior art, the depth of the separator groove cannot then be cut as deep as would be possible using material removal. However, due to the comparatively short length of the separator groove, bearing friction is insignificant thus making it possible for the separator groove to be made less deep than has previously been the case. The material removal in the bearing bush that occurs through the ECM process and that runs off during manufacture is also not very large.

According to a preferred embodiment of the invention, the grooved bearing patterns of the two radial bearings and the separator groove are cut using an electrochemical machining process, preferably in the same operation. This means that the grooved bearing patterns and the separator groove are made using one single ECM tool (electrode) in a single operation, which goes to greatly shorten the manufacturing time of the bearing. Moreover, important tolerances are determined predominately by the ECM electrode and are not accumulative since the grooved bearing patterns and the separator groove are manufactured in a single operation. This makes it possible to achieve high manufacturing precision. For this purpose, the ECM electrode is given a cylindrical shape and has grooved electrically conductive regions in those areas corresponding to areas on the inside wall of the bearing bush lying radially opposite in which bearing grooves or the separator groove are to be formed. Apart from that, the ECM electrode is electrically insulated. The ECM electrode is connected as a cathode, the work piece as an anode.

Where ECM is used to make the separator groove, a bearing system can now be produced whose overall height is preferably smaller than 3 millimeters, the overall height being defined by the length of the axial section of the bearing gap.

In the bearing system according to the invention, the distance d_{L} of the two radial bearings measured from the apex of the first radial bearing to the apex of the second radial bearing is preferably smaller than 1.5 millimeters. Accordingly, the length l_{S} of the separator groove is preferably smaller than 300 micrometers, preferably smaller than 200 micrometers.

Due to the ECM process, used not only for the grooved bearing patterns but also for the separator groove, the depth t_{R} of the bearing groove patterns and the depth of the separator groove t_{S} is preferably between 1 and 10 micrometers and substantially the same size.

In a preferred embodiment of the invention, however, the depth of the separator groove l_{S} may be somewhat larger than the depth of the grooved bearing patterns t_{R}, where:

t_{R}<=t_{S}<=1.5*t_{R}.

In the ECM process, it is possible to make the depth of the separator groove deeper by using correspondingly larger current densities in this region of the electrode, or this can be achieved more generally by the larger surface of the separator groove compared to the surface of the radial bearing patterns.

According to the invention, a method for cutting grooved bearing patterns and a separator groove in a surface of a component of a fluid dynamic bearing system is also described. The method is characterized in that the grooved bearing patterns of the two radial bearings and the separator groove are made using an electrochemical machining process, preferably in the same operation and using the same ECM electrode. The radial bearing patterns as well as the separator groove are preferably provided in the bearing bore of the bearing bush.

The bearing system according to the invention may be used for the rotatable support of a spindle motor that comprises a stator, a rotor and an electromagnetic drive system. A spindle motor of this kind may preferably be used to drive a storage disk of a hard disk drive in rotation.

The invention is explained in more detail below on the basis of a preferred embodiment with reference to the drawings. Further characteristics, advantages and possible applications of the invention can be derived from the drawings and their description.

### BRIEF DESCRIPTION OF THE DRAWINGS

FIG. 1 shows a longitudinal section through a spindle motor having a fluid dynamic bearing according to the invention.

FIG. 2a shows an enlarged section through the bearing bush having grooved bearing patterns and a separator groove of the same depth

FIG. 2b shows an enlarged section through the bearing bush having grooved bearing patterns and a separator groove of a larger depth

### DESCRIPTION OF A PREFERRED EMBODIMENT OF THE INVENTION

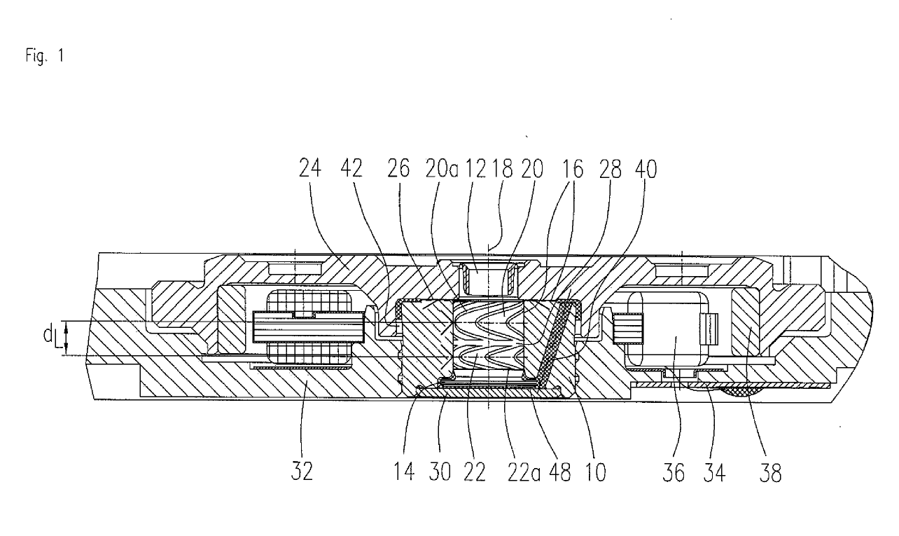

FIG. 1 shows a longitudinal section through a spindle motor having a fluid dynamic bearing according to the invention. The spindle motor comprises a stationary bearing bush 10 that has a central bore and forms the stationary part of the bearing system. A shaft 12 is inserted in the bore of the bearing bush 10, the diameter of the shaft being slightly smaller than the diameter of the bore. A bearing gap 16 remains between the surfaces of the bearing bush 10 and of the shaft 12. The opposing surfaces of the shaft 12 and of the bearing bush 10 form two fluid dynamic radial bearings 20, 22 by means of which the shaft 12 is rotatably supported about a rotational axis 18 in the bearing bush 10. The radial bearings 20, 22 are marked by grooved bearing patterns that are formed on the surface of the bearing bush 10 or of the shaft 12. The grooved bearing patterns 20a of the upper radial bearing 20 are preferably asymmetric with respect to a line through the apex 20b, the branches of the grooved bearing patterns 20a facing the upper end of the shaft 12 connected to the hub 24 being designed somewhat longer than the branches facing the separator groove 28. The grooved bearing patterns 22a of the lower radial bearing 22 are preferably made symmetric with respect to the line through the apex 22b and have branches of the same length. The bearing gap 16 is filled with an appropriate bearing fluid, such as a bearing oil. On rotation of the shaft 12, the grooved bearing patterns of the radial bearings 20, 22 exert a pumping effect on the bearing fluid found in the bearing gap 16 between the shaft 12 and the bearing bush 10. This causes pressure to be built up in the bearing gap that gives the radial bearings 20, 22 their load-carrying capacity. Due to the slightly asymmetric grooved bearing patterns 20a, the upper radial bearing 20 generates a pumping effect that is directed more strongly in the direction of the lower radial bearing 22 than in the direction of the axial bearing 26, whereas the lower radial bearing generates a uniform pumping effect in both directions of the bearing gap 16.

A free end of the shaft 12 is connected to a hub 24 that has a cylindrical shoulder which partially encloses the bearing bush 10. A lower, flat surface of the hub 24, together with an end face of the bearing bush 10, forms a fluid dynamic axial bearing 26. The end face of the bearing bush 10 or the opposing surface of the hub 24 are provided with grooved bearing patterns, which, on rotation of the shaft 12, exert a pumping effect on the bearing fluid found in the bearing gap 16 between the hub 24 and the end face of the bearing bush 10, thus giving the axial bearing 26 its load-carrying capacity. The pumping effect of the axial bearing 26 is directed radially inwards in the direction of the upper radial bearing 20. The bearing gap 16 comprises an axial section that extends along the shaft 10 and the two radial bearings 20, 22, and a radial section that extends along the end face of the bearing bush 10 and the axial bearing 26.

The grooved bearing patterns 20a, 22a of the radial bearings 20, 22 as well as the grooved bearing patterns of the axial bearing 26 are formed in the respective bearing surfaces in a well-known manner and, according to a preferred embodiment of the invention, using an electrochemical machining process (ECM). For this purpose, an ECM electrode is used that has an image on its surface of the grooved bearing patterns to be applied. Using the ECM process, grooved bearing patterns having a depth of 1 to 10 micrometers are formed in the surface of at least one of the opposing bearing parts, preferably in the bearing bush 10. According to the invention, the separator groove is now cut into the bearing part preferably in the same operation, namely between the respective grooved bearing patterns of the two radial bearings. Since the separator groove is relatively narrow, for example, less than 300 micrometers, preferably 200 micrometers, it can be easily realized using an ECM process.

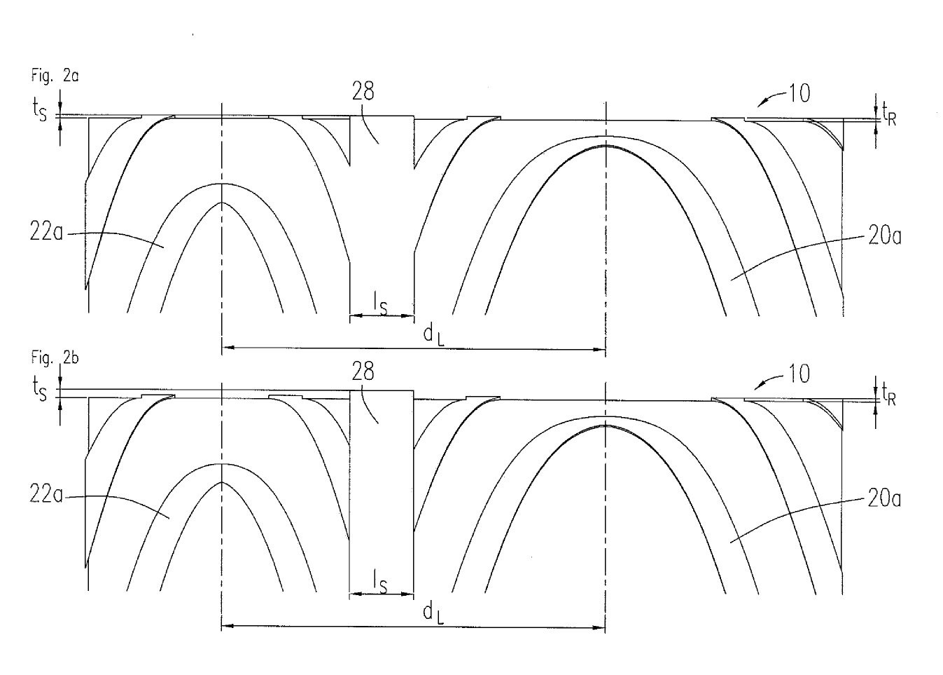

FIG. 2a shows a section of the bearing bush 10 in a first embodiment of the invention. The bearing grooves 20a and 22a of the two radial bearings 20 and 22 as well as the separator groove 28 disposed between the radial bearings can be seen. The two radial bearings 20, 22 have a bearing distance d_{L} of less than 1.5 millimeters, preferably 1.2 millimeters. The axial length l_{S} of the separator groove 28 is less than 0.3 millimeters, preferably 0.2 millimeters. In the example illustrated in FIG. 2a, the bearing distance d_{L} is approx. 1.46 mm and the axial length l_{S} of the separator groove 28 is approximately 0.16 mm. The ratio of d_{L}/l_{S} is thus approximately 9 (nine). Moreover, the depth t_{S} of the separator groove 28 is the same size as the depth t_{R} of the radial bearing grooves. The depth t_{R}=t_{S} may lie between 1 and 10 micrometers.

FIG. 2b shows a section of a bearing bush according to FIG. 2a, where the depth t_{S} of the separator groove 28, however, is larger than the depth t_{R} of the grooved bearing patterns of the radial bearings. The depth is preferably t_{S}<=1.5*t_{R}.

FIG. 1 further shows that a stopper ring 14 is disposed at the bottom of the shaft 12, the stopper ring being formed integrally with the shaft as one piece or formed separately and having a larger outside diameter compared to the diameter of the shaft. The stopper ring 14 prevents the shaft 12 from falling out of the bearing bush 10. The bearing is sealed on this side of the bearing bush 10 by a cover plate 30. A gap 48 filled with bearing fluid that is connected to the bearing gap remains between the surfaces of the stopper ring 14 and the surfaces of the bearing bush 10 or of the cover plate 30. The stopper ring 14 thus rotates together with the shaft within the recess between the bearing bush 10 and the cover plate 30 in bearing fluid.

A gap having a larger gap spacing is disposed at the radially outer end of the radial section of the bearing gap 16, this gap acting partly as a sealing gap 42. Starting from the bearing gap 16, the gap extends radially outwards and merges into an axial section that extends along the outside circumference of the bearing bush 10 between the bearing bush 10 and a cylindrical shoulder of the hub 24 and forms the sealing gap 42. The outer sleeve surface of the bearing bush 10 and the inner sleeve surface of the hub 24 form the boundary of the sealing gap 42. The sealing gap 42 thus runs approximately parallel to the rotational axis 18.

A recirculation channel 40 may be provided in the bearing bush 10, the recirculation channel 40 connecting a section of the bearing gap 16 located at the outer edge of the axial bearing 26 to a section of the bearing gap 16 located below the lower radial bearing 24 to one another and aiding the circulation of bearing fluid in the bearing.

The bearing bush 10 is disposed in a baseplate 32 of the spindle motor. The hub 24 has a circumferential rim at its outside circumference. A stator arrangement 36 enclosing the bearing bush 10 is disposed in the baseplate 32, the stator arrangement 36 being made up of a ferromagnetic stack of laminations and corresponding stator windings. This stator arrangement 36 is enclosed at a radial distance by an annular rotor magnet 38. The rotor magnet 38 is fixed at the inside circumference of the circumferential rim of the hub 24. The stator windings are electrically connected via a connector board 34.

The drive system has an axial offset between the magnetic center of the rotor magnet and the magnetic center of the stack of stator laminations. This produces a static magnetic force directed downwards in the direction of the baseplate 32. This magnetic force acts in opposition to the bearing force of the axial bearing 26 and serves as the axial preload of the bearing system or of the axial bearing 26.

### IDENTIFICATION REFERENCE LIST

10 Bearing bush
12 Shaft
14 Stopper ring
16 Bearing gap
18 Rotational axis
20 Radial bearing
20a Grooved bearing patterns
20b Apex line
22 Radial bearing
22a Grooved bearing patterns
22b Apex line
24 Hub
26 Axial bearing
28 Separator groove
30 Cover plate
32 Baseplate
34 Connector board
36 Stator arrangement
38 Rotor magnet
40 Recirculation channel
42 Sealing gap
48 Gap
d_{L} Bearing distance
l_{S} Axial length of the separator groove
t_{R} Depth of the grooved bearing patterns
t_{S} Depth of the separator groove

1. A fluid dynamic bearing system used particularly in a spindle motor for driving the storage disks of a hard disk drive, comprising:
a bearing bush (10),
a shaft (12) rotatably supported in a bearing bore of the bearing bush (10),
a hub (24) connected to the shaft (12),
a bearing gap (16) filled with bearing fluid having an axial section between mutually opposing surfaces of the shaft (12) and of the bearing bush (10),
a first and a second fluid dynamic radial bearing (20, 22) formed by grooved bearing patterns on associated bearing surfaces of the shaft (12) and/or of the bearing bush (10), wherein the two radial bearings (20; 22) have a mutual distance d_{L} measured from an apex line (20b) of the first radial bearing (20) to an apex line (22b) of the second radial bearing (22), and
a separator groove (28) that is disposed in the bearing bush (10) or in the shaft (12) in the axial section of the bearing gap between the two radial bearings and has an axial length l_{S},
wherein the ratio between the distance d_{L} and the length l_{S} is greater than 5 (five).

2. A fluid dynamic bearing system according to claim 1, characterized in that the ratio between the distance d_{L} and the length l_{S} is greater than 8 (eight).

3. A fluid dynamic bearing system according to claim 1, characterized in that the bearing gap forms a radial section between mutually opposing surfaces of the shaft (12) and of the hub (24), which forms at least one fluid dynamic axial bearing (26) that has grooved bearing patterns on associated bearing surfaces of the bearing bush (10) and/or the hub (24).

4. A fluid dynamic bearing system according to claim 1, characterized in that the grooved bearing patterns (20a, 22a) of the two radial bearings (20; 22) and the separator groove (28) are disposed in the bearing bush (10).

5. A fluid dynamic bearing system according to claim 1, characterized in that it has an overall height that is defined by the length of the axial section of the bearing gap (16) and is less than 3 mm.

6. A fluid dynamic bearing system according to claim 1, characterized in that the distance d_{L} between the two radial bearings (20; 22) is less than 1.5 mm.

7. A fluid dynamic bearing system according to claim 1, characterized in that the axial length l_{S} of the separator groove (28) is less than 300 micrometers.

8. A fluid dynamic bearing system according to claim 4, characterized in that the depth t_{R} of the grooved bearing patterns (20a, 22a) of the radial bearings (20, 22) is 1 to 10 micrometers.

9. A fluid dynamic bearing system according to claim 8, characterized in that for the depth t_{S} of the separator groove (28) and for the depth t_{R} of the grooved bearing patterns (20a, 22a) of the radial bearings (20, 22) the following inequality applies: t_{R}<=t_{S}<=1.5*t_{R}.

10. A fluid dynamic bearing system according to claim 1, characterized in that the grooved bearing patterns (20a, 22a) of the two radial bearings (20; 22) and the separator groove (28) are manufactured using an electrochemical machining process (ECM).

11. A fluid dynamic bearing system according to claim 1, characterized in that the grooved bearing patterns (20a, 22a) of the two radial bearings (20; 22) and the separator groove (28) are manufactured in the same operation.

12. A spindle motor having a stator and a rotor that is rotatably supported with respect to the stator by means of the fluid dynamic bearing system, and an electromagnetic drive system (36, 38) for driving the rotor, wherein the fluid dynamic bearing system comprises:
a bearing bush (10),
a shaft (12) rotatably supported in a bearing bore of the bearing bush (10),
a hub (24) connected to the shaft (12),
a bearing gap (16) filled with bearing fluid having an axial section between mutually opposing surfaces of the shaft (12) and of the bearing bush (10),
a first and a second fluid dynamic radial bearing (20, 22) formed by grooved bearing patterns on associated bearing surfaces of the shaft (12) and/or of the bearing bush (10), wherein the two radial bearings (20; 22) have a mutual distance d_{L} measured from an apex line (20b) of the first radial bearing (20) to an apex line (22b) of the second radial bearing (22), and
a separator groove (28) that is disposed in the bearing bush (10) or in the shaft (12) in the axial section of the bearing gap between the two radial bearings and has an axial length l_{S},
wherein the ratio between the distance d_{L} and the length l_{S} is greater than 5 (five).

13. A hard disk drive having a spindle motor for driving in rotation at least one magnetic storage disk, and a read/write device for reading and writing data from and to the magnetic storage disk, wherein the spindle motor comprises a stator and a rotor and an electromagnetic drive system (36, 38) for driving the rotor, wherein a fluid dynamic bearing system is provided for the rotatable support of the rotor, the fluid dynamic bearing system comprising:
a bearing bush (10),
a shaft (12) rotatably supported in a bearing bore of the bearing bush (10),
a hub (24) connected to the shaft (12),
a bearing gap (16) filled with bearing fluid having an axial section between mutually opposing surfaces of the shaft (12) and of the bearing bush (10),
a first and a second fluid dynamic radial bearing (20, 22) formed by grooved bearing patterns on associated bearing surfaces of the shaft (12) and/or of the bearing bush (10), wherein the two radial bearings (20; 22) have a mutual distance d_{L} measured from an apex line (20b) of the first radial bearing (20) to an apex line (22b) of the second radial bearing (22) and
a separator groove (28) that is disposed in the bearing bush (10) or the shaft (12) in the axial section of the bearing gap between the two radial bearings and has an axial length l_{S},
wherein the ratio between the distance d_{L} and the length l_{S} is greater than 5 (five).

14. A method for forming grooved bearing patterns (20a, 22a) and a separator groove (28) in a surface of a component of a fluid dynamic bearing system, wherein the grooved bearing patterns (20a, 22a) form a part of two fluid dynamic radial bearings (20, 22) that are separated from one another by the separator groove (28),
characterized in that
the grooved bearing patterns (20a, 22a) of the two radial bearings (20; 22) and the separator groove (28) are manufactured using an electrochemical machining process (ECM) such that the ratio between a distance d_{L} of the two radial bearings (20, 22) and a length l_{S} of the separator groove is greater than 5 (five).

15. A method according to claim 14, characterized in that the grooved bearing patterns (20a, 22a) of the two radial bearings (20; 22) and the separator groove (28) are manufactured in the same operation.

16. A method according to claim 15, characterized in that the grooved bearing patterns (20a, 22a) of the two radial bearings (20; 22) and the separator groove (28) are manufactured using the same ECM electrode.
